(19) United States
(12) Patent Application Publication
(10) Pub. No.: US 2017/0024077 A1
(43) Pub. Date: Jan. 26, 2017

(54) IN-CELL TOUCH PANEL DRIVING METHOD

(71) Applicant: Raydium Semiconductor Corporation, Hsinchu (TW)

(72) Inventors: Yi-Ying Lin, Hualien City (TW); Kun-Pei Lee, Miaoli County (TW); Chen-Wei Yang, Hsinchu City (TW); Chang-Ching Chiang, Taichung City (TW)

(21) Appl. No.: 15/215,708

(22) Filed: Jul. 21, 2016

Related U.S. Application Data
(60) Provisional application No. 62/196,403, filed on Jul. 24, 2015.

(51) Int. Cl. G06F 3/041; G06F 3/044

(52) U.S. Cl. CPC G06F 3/0418; G06F 3/044; G06F 3/0412

(57) ABSTRACT

An in-cell touch panel driving method for driving an in-cell touch panel is disclosed. The in-cell touch panel driving method includes a step of driving a touch sensing mode and a display mode of the in-cell touch panel in a time-sharing way and operating the in-cell touch panel in the touch sensing mode during a blanking interval of a display period of the in-cell touch panel.

This application claims priority to U.S. provisional application Ser. No. 62/196,403, filed Jul. 24, 2015, the contents of which are incorporated herein by reference.

### BACKGROUND OF THE INVENTION

1. Field of the Invention

This invention relates to touch panel, especially to an in-cell touch panel driving method.

2. Description of the Prior Art

In general, there are several different laminated structures of the capacitive touch panel, for example, an in-cell capacitive touch panel or an on-cell capacitive touch panel.

Please refer to FIG. 1 and FIG. 2. FIG. 1 and FIG. 2 illustrate two different laminated structures of the on-cell capacitive touch panel and the in-cell capacitive touch panel respectively. As shown in FIG. 1, the laminated structure 1 of the on-cell capacitive touch panel includes a substrate 10, a thin-film transistor layer 11, a liquid crystal layer 12, a color filtering layer 13, a glass layer 14, a touch sensing layer 15, a polarizer 16, an adhesive 17, and top lens 18. As shown in FIG. 2, the laminated structure 2 of the in-cell capacitive touch panel includes a substrate 20, a thin-film transistor layer 21, a touch sensing layer 22, a liquid crystal layer 23, a color filtering layer 24, a glass layer 25, a polarizer 26, an adhesive 27, and top lens 28.

After comparing FIG. 1 with FIG. 2, it can be found that the touch sensing layer 22 of the in-cell capacitive touch panel is disposed under the liquid crystal layer 23; that is to say, the touch sensing layer 22 is disposed in the liquid crystal display module of the in-cell capacitive touch panel. On the other hand, the touch sensing layer 15 of the on-cell capacitive touch panel is disposed above the glass layer 14; that is to say, the touch sensing layer 15 is disposed out of the liquid crystal display module of the on-cell capacitive touch panel. Therefore, compared to the conventional one glass solution (OGS) and on-cell capacitive touch panel, the in-cell capacitive touch panel can achieve thinnest touch panel design and widely used in portable electronic products such as mobile phones, tablet PCs and notebooks.

Therefore, the invention provides an in-cell touch panel driving method to reduce the effects of the resistance and parasitic capacitance and effectively enhance the entire performance of the in-cell mutual-capacitive touch panel.

### SUMMARY OF THE INVENTION

An embodiment of the invention is an in-cell touch panel driving method for driving an in-cell touch panel. In this embodiment, the in-cell touch panel driving method includes steps of: driving a touch sensing mode and a display mode of the in-cell touch panel in a time-sharing way; and operating the in-cell touch panel in the touch sensing mode during a blanking interval of a display period of the in-cell touch panel.

In an embodiment, the in-cell touch panel is an in-cell self-capacitive touch panel.

In an embodiment, the blanking interval includes at least one of a vertical blanking interval (VBI), a horizontal blanking interval (HBI) and a long horizontal blanking interval (LHBI).

In an embodiment, a time length of the long horizontal blanking interval is equal to or larger than a time length of the horizontal blanking interval.

In an embodiment, the long horizontal blanking interval is obtained by redistributing a plurality of horizontal blanking intervals.

In an embodiment, the long horizontal blanking interval includes the vertical blanking interval.

In an embodiment, when the in-cell touch panel is operated in the touch sensing mode, the in-cell touch panel driving method further includes steps of: lifting a touch signal of the in-cell touch panel from a common voltage level to a first level, wherein the first level is higher than the common voltage level; starting to provide a touch pulse on a reference of the first level; during the touch pulse, lifting the touch signal from the first level to a touch voltage level and then dropping the touch signal back to the first level, wherein the touch voltage level is higher than the first level; when the touch pulse ends, the touch signal is at the first level; and dropping the touch signal from the first level back to the common voltage level.

In an embodiment, when the in-cell touch panel is operated in the touch sensing mode, the in-cell touch panel driving method further includes steps of: lifting a touch signal of the in-cell touch panel from a common voltage level to a first level, wherein the first level is higher than the common voltage level; starting to provide a touch pulse on a reference of the first level; during the touch pulse, pre-charging the touch signal from the first level to a second level and then dropping the touch signal to a touch voltage level, wherein the second level is higher than the touch voltage level and the touch voltage level is higher than the first level; when the touch pulse ends, the touch signal is at the first level; and dropping the touch signal from the first level back to the common voltage level.

In an embodiment, when the in-cell touch panel is operated in the touch sensing mode, the in-cell touch panel driving method further includes steps of: lifting a touch signal of the in-cell touch panel from a common voltage level to a first level, wherein the first level is higher than the common voltage level; starting to provide a touch pulse on a reference of the first level; during the touch pulse, pre-charging the touch signal from the first level to a second level and dropping the touch signal to a touch voltage level, and then pre-discharging the touch signal from the touch voltage level to the common voltage level and then lifting the touch signal back to the first level, wherein the second level is higher than the touch voltage level and the touch voltage level is higher than the first level; when the touch pulse ends, the touch signal is at the first level; and dropping the touch signal from the first level back to the common voltage level.

In an embodiment, when the in-cell touch panel is operated in the touch sensing mode, the in-cell touch panel driving method further includes steps of: lifting a touch signal of the in-cell touch panel from a common voltage level to a first level, wherein the first level is higher than the common voltage level; starting to provide a touch pulse on a reference of the first level; during the touch pulse, lifting the touch signal from the first level to a touch voltage level, and then pre-discharging the touch signal from the touch voltage level to the common voltage level and then lifting the touch signal back to the first level, wherein the touch voltage level is higher than the first level; when the touch pulse ends, the touch signal is at the first level; and dropping the touch signal from the first level back to the common voltage level.

In an embodiment, when the in-cell touch panel is operated in the touch sensing mode, the in-cell touch panel driving method further includes a step of: providing a touch related signal to a source line and/or a gate line of the in-cell touch panel.

In an embodiment, the touch related signal and a touch signal of the in-cell touch panel have the same frequency and different phases.

In an embodiment, a phase of the touch related signal leads a phase of the touch signal.

In an embodiment, a phase of the touch related signal lags behind a phase of the touch signal.

In an embodiment, a touch sensor and a common voltage electrode of the in-cell touch panel are not electrically connected, and the in-cell touch panel driving method further includes a step of: when the in-cell touch panel is operated in the touch sensing mode, switching the common voltage electrode to a floating level.

In an embodiment, a touch signal of the in-cell touch panel includes a plurality of pulses.

In an embodiment, the plurality of pulses is divided into at least one group of pulses.

In an embodiment, the plurality of pulses includes a dummy pulse and a touch pulse having the same frequency.

In an embodiment, a touch signal of the in-cell touch panel has a periodic waveform.

In an embodiment, the periodic waveform is a rectangle wave, a sine wave or a triangle wave.

In an embodiment, a common voltage electrode signal provided to a common voltage electrode of the in-cell touch panel is a touch related signal to reduce a RC loading when the in-cell touch panel is operated in the touch sensing mode.

Compared to the prior art, the in-cell touch panel driving method of the invention has the following advantages and effects:

(1) The touch sensing mode and the display mode of the in-cell touch panel are driven in a time-sharing way to increase the signal-to-noise ratio.

(2) The in-cell touch panel operated in the long horizontal blanking interval (LHBI) of the display period of the in-cell touch panel can have sufficient charging/discharging time.

(3) The time needed for charging or discharging can be reduced through a pre-charging way or a pre-discharging way.

(4) The source line and/or gate line are provided the signal having the same frequency and different phases with the touch signal to reduce the RC loading when the touch sensing is performed, and the time needed for charging or discharging can be effectively reduced.

(5) When the in-cell touch panel is operated in the touch sensing mode, the common voltage electrode is switched to the floating level or provided the signal corresponding to the touch signal to effectively reduce the RC loading when touch sensing is performed.

(6) Using the dummy pulse as the buffer when the touch sensing is started to make sure that the correct touch sensing value will be obtained when the touch pulse is sensed.

The advantage and spirit of the invention may be understood by the following detailed descriptions together with the appended drawings.

### BRIEF DESCRIPTION OF THE APPENDED DRAWINGS

FIG. 1 and FIG. 2 illustrate two different laminated structures of the on-cell capacitive touch panel and the in-cell capacitive touch panel respectively.

FIG. 3 illustrates a schematic diagram of the in-cell touch panel operated in the touch mode outputting the touch driving signal during the blanking interval of the image signal.

FIG. 4 illustrates schematic diagrams of the vertical blanking interval (VBI), the horizontal blanking interval (HBI) and the long horizontal blanking interval (LHBI).

FIG. 5 illustrates a flowchart of the in-cell touch panel driving method of the invention.

FIG. 6A illustrates a flowchart of the in-cell touch panel driving method in the first embodiment of the invention.

FIG. 6B illustrates a timing diagram of the touch signal voltage level changes corresponding to FIG. 6A.

FIG. 7A illustrates a flowchart of the in-cell touch panel driving method in the second embodiment of the invention.

FIG. 7B illustrates a timing diagram of the touch signal voltage level changes corresponding to FIG. 7A.

FIG. 8A illustrates a flowchart of the in-cell touch panel driving method in the third embodiment of the invention.

FIG. 8B illustrates a timing diagram of the touch signal voltage level changes corresponding to FIG. 8A.

FIG. 9 illustrates a timing diagram of the phase of the touch related signal lagging behind the phase of the touch signal when the in-cell touch panel is operated in the touch sensing mode.

FIG. 10 illustrates a timing diagram of the phase of the touch related signal leading the phase of the touch signal when the in-cell touch panel is operated in the touch sensing mode.

FIG. 11 illustrates a timing diagram of the common voltage electrode switched to the floating level when the in-cell touch panel is operated in the touch sensing mode.

FIG. 12 illustrates a schematic diagram of the touch signal of the in-cell touch panel including the dummy pulses and the touch pulses.

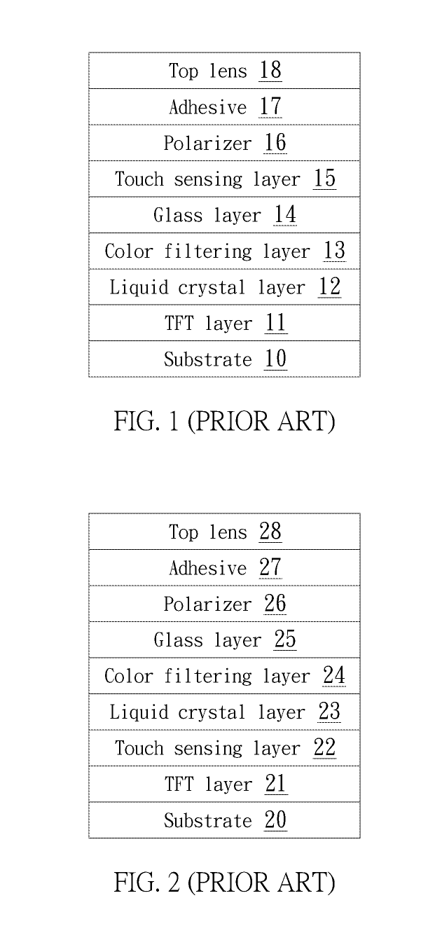

### DETAILED DESCRIPTION OF THE INVENTION

A preferred embodiment of the invention is an in-cell touch panel driving method. In this embodiment, the in-cell touch panel driving method is used to drive an in-cell touch panel which is an in-cell mutual-capacitive touch panel, but not limited to this.

It should be noticed that the in-cell touch panel driving method of the invention is to drive the in-cell touch panel to operate in the display mode and the touch mode at different times respectively. That is to say, the touch mode and the display mode of the in-cell touch panel of the invention are driven in a time-sharing way.

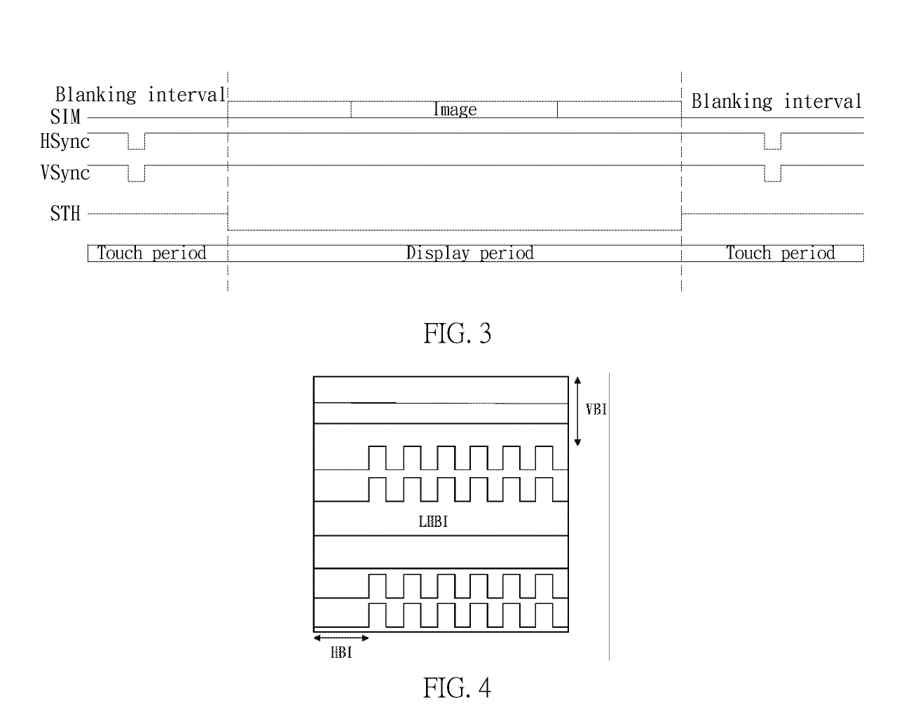

Please refer to FIG. 3. As shown in FIG. 3, the in-cell mutual-capacitive touch panel operated in the touch mode will output the touch driving signal STH during the blanking interval of the image signal SIM. The in-cell mutual-capacitive touch panel will perform the touch sensing during non-display timing (e.g., the blanking interval).

Please also refer to FIG. 4. FIG. 4 illustrates schematic diagrams of the vertical blanking interval (VBI), the horizontal blanking interval (HBI) and the long horizontal blanking interval (LHBI). In practical applications, the various kinds of blanking intervals used by the in-cell mutual-capacitive touch panel can be adjusted based on different driving ways. AS shown in FIG. 4, the blanking interval can include at least one of the vertical blanking interval VBI, the horizontal blanking interval HBI and the long horizontal blanking interval LHBI. The long horizontal blanking interval LHBI has a time length equal to or larger than that of the horizontal blanking interval HBI. The long horizontal blanking interval LHBI is obtained by redistributing a plurality of the horizontal blanking interval HBI or the long horizontal blanking interval LHBI includes the vertical blanking interval VBI.

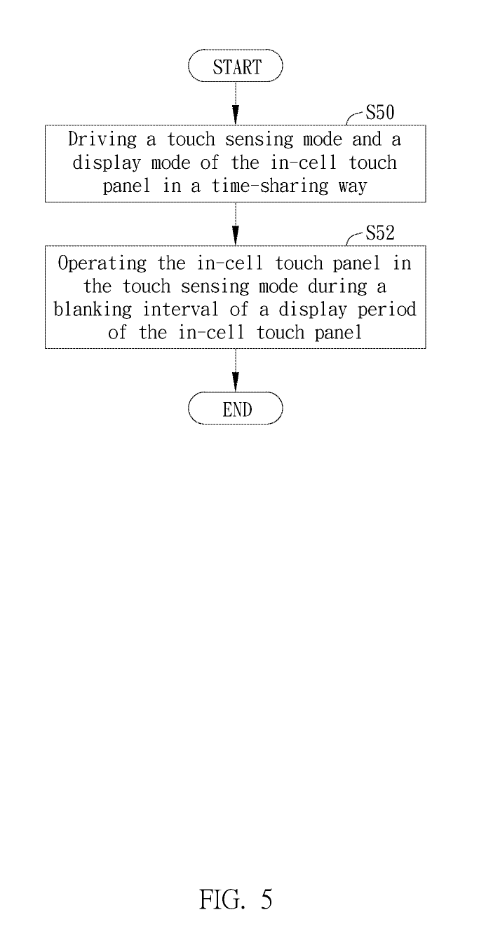

Please refer to FIG. 5. FIG. 5 illustrates a flowchart of the in-cell touch panel driving method of the invention. As shown in FIG. 5, in this embodiment, the in-cell touch panel driving method includes the following steps:

Step S50: driving a touch sensing mode and a display mode of the in-cell touch panel in a time-sharing way; and

Step S52: operating the in-cell touch panel in the touch sensing mode during a blanking interval of a display period of the in-cell touch panel.

It should be noticed that if the in-cell touch panel is operated by the method in the long horizontal blanking interval LHBI of the display period of the in-cell touch panel, it can have very sufficient charging/discharging time and the method of the invention can effectively reduce the time needed for charging and discharging through the pre-charging way and the pre-discharging way.

Then, different examples will be introduced as follows to explain the in-cell touch panel driving method and its pre-charging /pre-discharging ways in the invention.

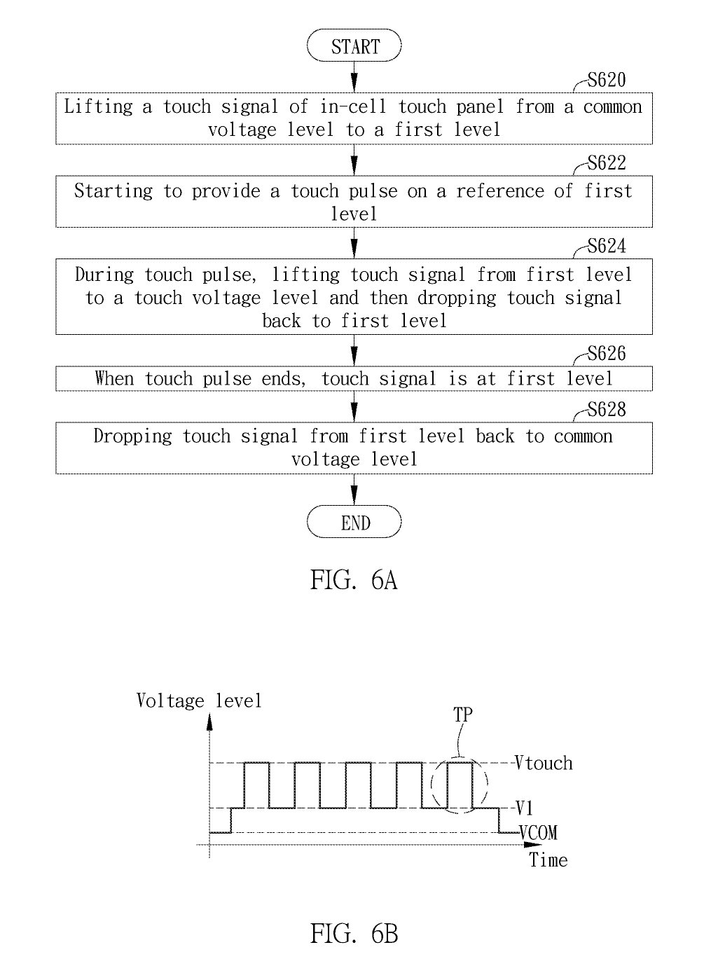

At first, please refer to FIG. 6A and FIG. 6B. FIG. 6A illustrates a flowchart of the in-cell touch panel driving method in the first embodiment of the invention; FIG. 6B illustrates a timing diagram of the touch signal voltage level changes corresponding to FIG. 6A.

As shown in FIG. 6A and FIG. 6B, in this embodiment, when the in-cell touch panel is operated in the touch sensing mode, the in-cell touch panel driving method further includes steps of:

Step S620: lifting a touch signal of the in-cell touch panel from a common voltage level VCOM to a first level V1, wherein the first level V1 is higher than the common voltage level VCOM;

Step S622: starting to provide a touch pulse TP on a reference of the first level V1;

Step S624: during the touch pulse TP, lifting the touch signal from the first level V1 to a touch voltage level Vtouch and then dropping the touch signal back to the first level V1, wherein the touch voltage level Vtouch is higher than the first level V1;

Step S626: when the touch pulse TP ends, the touch signal is at the first level V1; and

Step S628: dropping the touch signal from the first level V1 back to the common voltage level VCOM.

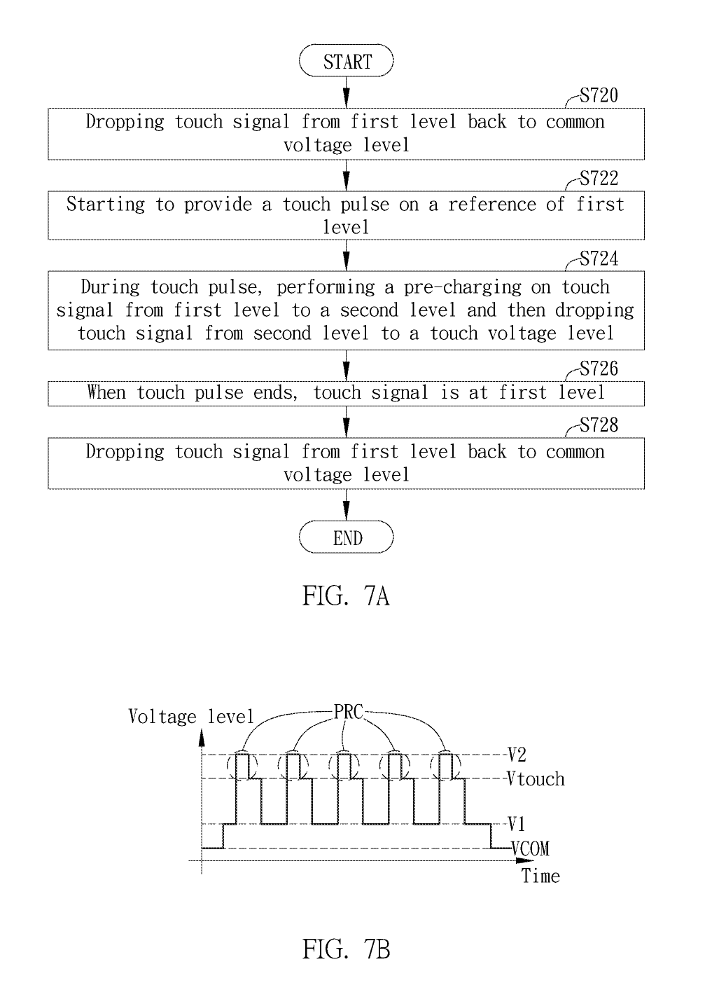

Then, please refer to FIG. 7A and FIG. 7B. FIG. 7A illustrates a flowchart of the in-cell touch panel driving method in the second embodiment of the invention; FIG. 7B illustrates a timing diagram of the touch signal voltage level changes corresponding to FIG. 7A.

As shown in FIG. 7A and FIG. 7B, in this embodiment, when the in-cell touch panel is operated in the touch sensing mode, the in-cell touch panel driving method further includes steps of:

Step S720: lifting a touch signal of the in-cell touch panel from a common voltage level VCOM to a first level V1, wherein the first level V1 is higher than the common voltage level VCOM;

Step S722: starting to provide a touch pulse TP on a reference of the first level V1;

Step S724: during the touch pulse TP, performing a pre-charging PRC on the touch signal from the first level V1 to a second level V2 and then dropping the touch signal from the second level V2 to a touch voltage level Vtouch, wherein the second level V2 is higher than the touch voltage level Vtouch and the touch voltage level Vtouch is higher than the first level V1;

Step S726: when the touch pulse TP ends, the touch signal is at the first level V1; and

Step S728: dropping the touch signal from the first level V1 back to the common voltage level VCOM.

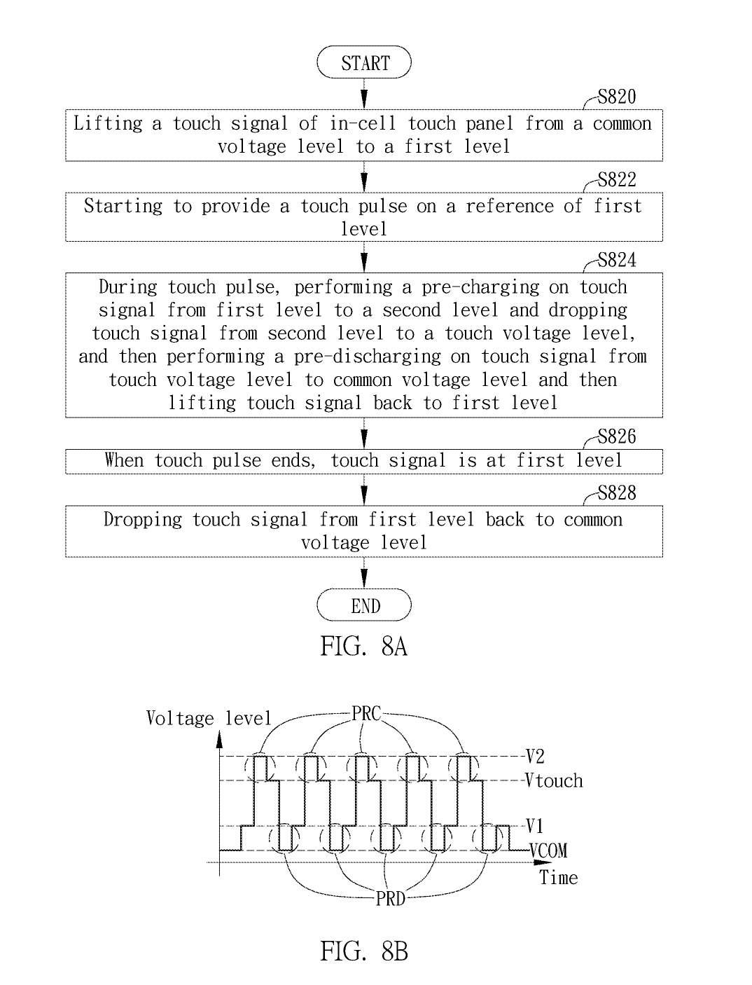

Then, please refer to FIG. 8A and FIG. 8B. FIG. 8A illustrates a flowchart of the in-cell touch panel driving method in the third embodiment of the invention; FIG. 8B illustrates a timing diagram of the touch signal voltage level changes corresponding to FIG. 8A.

As shown in FIG. 8A and FIG. 8B, in this embodiment, when the in-cell touch panel is operated in the touch sensing mode, the in-cell touch panel driving method further includes steps of:

Step S820: lifting a touch signal of the in-cell touch panel from a common voltage level VCOM to a first level V1, wherein the first level V1 is higher than the common voltage level VCOM;

Step S822: starting to provide a touch pulse TP on a reference of the first level V1;

Step S824: during the touch pulse TP, performing a pre-charging PRC on the touch signal from the first level V1 to a second level V2 and dropping the touch signal from the second level V2 to a touch voltage level Vtouch, and then performing a pre-discharging PRD on the touch signal from the touch voltage level Vtouch to the common voltage level VCOM and then lifting the touch signal back to the first level V1, wherein the second level V2 is higher than the touch voltage level Vtouch and the touch voltage level Vtouch is higher than the first level V1;

Step S826: when the touch pulse TP ends, the touch signal is at the first level V1; and

Step S828: dropping the touch signal from the first level V1 back to the common voltage level VCOM.

According to the above-mentioned embodiments, it can be found that the invention can effectively reduce the time needed for charging and discharging through the pre-charging way and the pre-discharging way.

It should be noticed that when the in-cell touch panel is operated in the touch sensing mode, the in-cell touch panel driving method of the invention can further provide a touch related signal to a source line and/or a gate line of the in-cell touch panel respectively, and the touch related signal and a touch signal of the in-cell touch panel can have the same frequency and different phases to reduce the RC loading when the touch sensing is performed and effectively reduce the time needed for charging and discharging.

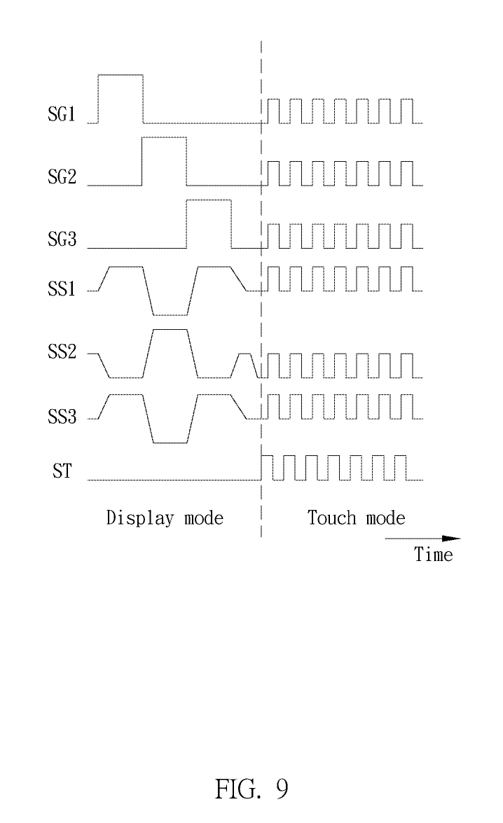

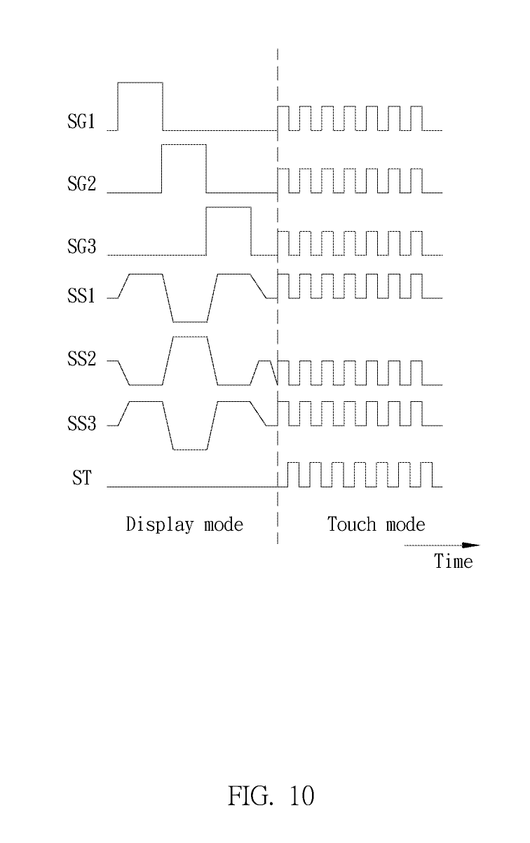

For example, please refer to FIG. 9 and FIG. 10. FIG. 9 illustrates a timing diagram of the phase of the touch related signals SG1˜SG3 and SS1˜SS3 lagging behind the phase of the touch signal ST when the in-cell touch panel is operated in the touch sensing mode; FIG. 10 illustrates a timing diagram of the phase of the touch related signals SG1˜SG3 and SS1˜SS3 leading the phase of the touch signal ST when the in-cell touch panel is operated in the touch sensing mode.

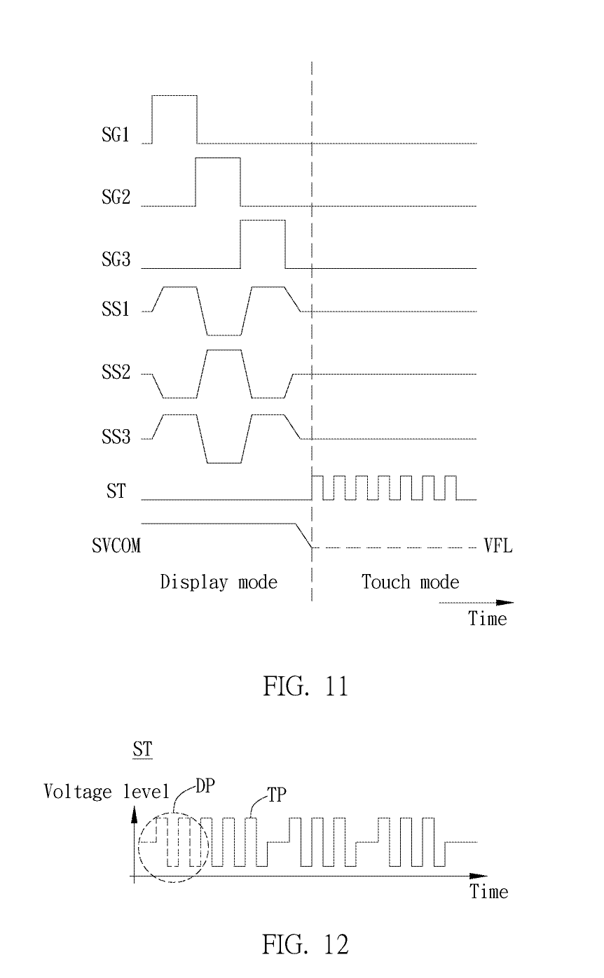

In addition, the touch sensor and the common voltage electrode of the in-cell touch panel in the invention can be also electrically disconnected. As shown in FIG. 11, when the in-cell touch panel is operated in the touch sensing mode, the method of the invention can further change the common voltage electrode signal SVCOM provided to the common voltage electrode to the floating level VFL to effectively reduce the RC loading when the touch sensing is performed, but not limited to this.

In another embodiment, the common voltage electrode signal SVCOM provided to the common voltage electrode of the in-cell touch panel can be a touch related signal to reduce a RC loading when the in-cell touch panel is operated in the touch sensing mode, but also not limited to this.

In practical applications, the touch signal ST of the in-cell touch panel can have a periodic waveform, such as a rectangle wave, a sine wave or a triangle wave, but not limited to this. Furthermore, the touch signal of the in-cell touch panel can include a plurality of pulses and the plurality of pulses can be divided into at least one group of pulses.

Please refer to FIG. 12. As shown in FIG. 12, the plurality of pulses of the touch signal ST includes a dummy pulse DP and a touch pulse TP having the same frequency, but not limited to this. It should be noticed that the dummy pulse DP in the touch signal ST can be used as the buffer when the touch sensing is started, so that it can make sure that the correct touch sensing value can be obtained when the touch pulse TP is sensed.

Compared to the prior art, the in-cell touch panel driving method of the invention has the following advantages and effects:

(1) The touch sensing mode and the display mode of the in-cell touch panel are driven in a time-sharing way to increase the signal-to-noise ratio.

(2) The in-cell touch panel operated in the long horizontal blanking interval (LHBI) of the display period of the in-cell touch panel can have sufficient charging/discharging time.

(3) The time needed for charging or discharging can be reduced through a pre-charging way or a pre-discharging way.

(4) The source line and/or gate line are provided the signal having the same frequency and different phases with the touch signal to reduce the RC loading when the touch sensing is performed, and the time needed for charging or discharging can be effectively reduced.

(5) When the in-cell touch panel is operated in the touch sensing mode, the common voltage electrode is switched to the floating level or provided the signal corresponding to the touch signal to effectively reduce the RC loading when touch sensing is performed.

(6) Using the dummy pulse as the buffer when the touch sensing is started to make sure that the correct touch sensing value will be obtained when the touch pulse is sensed.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An in-cell touch panel driving method for driving an in-cell touch panel, comprising steps of:
driving a touch sensing mode and a display mode of the in-cell touch panel in a time-sharing way; and
operating the in-cell touch panel in the touch sensing mode during a blanking interval of a display period of the in-cell touch panel.

2. The in-cell touch panel driving method of claim 1, wherein the in-cell touch panel is an in-cell self-capacitive touch panel.

3. The in-cell touch panel driving method of claim 1, wherein the blanking interval comprises at least one of a vertical blanking interval (VBI), a horizontal blanking interval (HBI) and a long horizontal blanking interval (LHBI).

4. The in-cell touch panel driving method of claim 3, wherein a time length of the long horizontal blanking interval is equal to or larger than a time length of the horizontal blanking interval.

5. The in-cell touch panel driving method of claim 3, wherein the long horizontal blanking interval is obtained by redistributing a plurality of horizontal blanking intervals.

6. The in-cell touch panel driving method of claim 3, wherein the long horizontal blanking interval comprises the vertical blanking interval.

7. The in-cell touch panel driving method of claim 1, wherein when the in-cell touch panel is operated in the touch sensing mode, the in-cell touch panel driving method further comprises steps of:
lifting a touch signal of the in-cell touch panel from a common voltage level to a first level, wherein the first level is higher than the common voltage level;
starting to provide a touch pulse on a reference of the first level;
during the touch pulse, lifting the touch signal from the first level to a touch voltage level and then dropping the touch signal back to the first level, wherein the touch voltage level is higher than the first level;
when the touch pulse ends, the touch signal being at the first level; and
dropping the touch signal from the first level back to the common voltage level.

8. The in-cell touch panel driving method of claim 1, wherein when the in-cell touch panel is operated in the touch sensing mode, the in-cell touch panel driving method further comprises steps of:
lifting a touch signal of the in-cell touch panel from a common voltage level to a first level, wherein the first level is higher than the common voltage level;
starting to provide a touch pulse on a reference of the first level;
during the touch pulse, pre-charging the touch signal from the first level to a second level and then dropping the touch signal to a touch voltage level, wherein the second level is higher than the touch voltage level and the touch voltage level is higher than the first level;
when the touch pulse ends, the touch signal being at the first level; and
dropping the touch signal from the first level back to the common voltage level.

9. The in-cell touch panel driving method of claim 1, wherein when the in-cell touch panel is operated in the touch sensing mode, the in-cell touch panel driving method further comprises steps of:
lifting a touch signal of the in-cell touch panel from a common voltage level to a first level, wherein the first level is higher than the common voltage level;
starting to provide a touch pulse on a reference of the first level;
during the touch pulse, pre-charging the touch signal from the first level to a second level and dropping the touch signal to a touch voltage level, and then pre-discharging the touch signal from the touch voltage level to the common voltage level and then lifting the touch signal back to the first level, wherein the second level is higher than the touch voltage level and the touch voltage level is higher than the first level;
when the touch pulse ends, the touch signal being at the first level; and
dropping the touch signal from the first level back to the common voltage level.

10. The in-cell touch panel driving method of claim 1, wherein when the in-cell touch panel is operated in the touch sensing mode, the in-cell touch panel driving method further comprises steps of:
lifting a touch signal of the in-cell touch panel from a common voltage level to a first level, wherein the first level is higher than the common voltage level;
starting to provide a touch pulse on a reference of the first level;
during the touch pulse, lifting the touch signal from the first level to a touch voltage level, and then pre-discharging the touch signal from the touch voltage level to the common voltage level and then lifting the touch signal back to the first level, wherein the touch voltage level is higher than the first level;
when the touch pulse ends, the touch signal being at the first level; and
dropping the touch signal from the first level back to the common voltage level.

11. The in-cell touch panel driving method of claim 1, wherein when the in-cell touch panel is operated in the touch sensing mode, the in-cell touch panel driving method further comprises a step of:
providing a touch related signal to a source line and/or a gate line of the in-cell touch panel.

12. The in-cell touch panel driving method of claim 11, wherein the touch related signal and a touch signal of the in-cell touch panel have the same frequency and different phases.

13. The in-cell touch panel driving method of claim 12, wherein a phase of the touch related signal leads a phase of the touch signal.

14. The in-cell touch panel driving method of claim 12, wherein a phase of the touch related signal lags behind a phase of the touch signal.

15. The in-cell touch panel driving method of claim 1, wherein a touch sensor and a common voltage electrode of the in-cell touch panel are not electrically connected, the in-cell touch panel driving method further comprises a step of:
when the in-cell touch panel is operated in the touch sensing mode, switching the common voltage electrode to a floating level.

16. The in-cell touch panel driving method of claim 1, wherein a touch signal of the in-cell touch panel comprises a plurality of pulses.

17. The in-cell touch panel driving method of claim 16, wherein the plurality of pulses is divided into at least one group of pulses.

18. The in-cell touch panel driving method of claim 16, wherein the plurality of pulses comprises a dummy pulse and a touch pulse having the same frequency.

19. The in-cell touch panel driving method of claim 1, wherein a touch signal of the in-cell touch panel has a periodic waveform.

20. The in-cell touch panel driving method of claim 19, wherein the periodic waveform is a rectangle wave, a sine wave or a triangle wave.

21. The in-cell touch panel driving method of claim 1, wherein a common voltage electrode signal provided to a common voltage electrode of the in-cell touch panel is a touch related signal to reduce a RC loading when the in-cell touch panel is operated in the touch sensing mode.
